(19) United States
(12) Patent Application Publication
(10) Pub. No.: US 2019/0319881 A1
(43) Pub. Date: Oct. 17, 2019

(54) TRAFFIC MANAGEMENT BASED ON PAST TRAFFIC ARRIVAL PATTERNS

(71) Applicant: Microsoft Technology Licensing, LLC, Redmond, WA (US)

(72) Inventors: Rajesh Maskara, Redmond, WA (US); Gregory Thiel, Black Diamond, WA (US); Bradley Rutkowski, Woodinville, WA (US); Todd Luttinen, Redmond, WA (US); Saraswathy Srinivasan, Sammamish, WA (US)

(21) Appl. No.: 15/953,013

(22) Filed: Apr. 13, 2018

(51) Int. Cl. H04L 12/741; H04L 29/12; H04L 12/911

(52) U.S. Cl. CPC H04L 45/74; H04L 61/1511; H04L 41/12; H04L 61/6068; H04L 47/72

(57) ABSTRACT

Various embodiments of the present technology generally relate to systems and methods for intelligent traffic management and routing. More specifically, various embodiments of the present technology generally relate to intelligent traffic management of cloud-based services based on predicted traffic and current load capacity of servers or scaling units. In some embodiments, traffic associated with one or more subnets can be monitored. Then using a record of historical traffic patterns and current traffic patterns, a prediction of future traffic can be generated. The predication can then be translated into an estimated load for one or more scaling units or servers. The current status of the one or more scaling units capable of handling traffic can be determined and future traffic can be routed based on the prediction generated and the status of the one or more scaling units.

### BACKGROUND

Modern electronic devices such as computers, tablets, mobile phones, wearable devices and the like have become a common part of modern life. Many users of electronic devices routinely utilize various types of software applications for business and personal activities. Examples of software applications can include word processors, spreadsheet applications, e-mail clients, notetaking software, presentation applications, games, computational software, and others. These software applications can also be used to perform calculations, produce charts, organize data, receive and send e-mails, communicate in real-time with others, and the like. The software applications can range from simple software to very complex software. Moreover, there are a variety of channels for delivering software and services to end-users such as cloud computing services.

Examples of popular cloud computing services include, but not limited to, software as a service (SaaS), platform as a service (PaaS), and the like. For example, SaaS is becoming a popular delivery mechanism where software applications are consumed by end-users over the internet. As a result, end-users do not have to install and run the applications locally as the applications are maintained in the cloud by the service provider. With these types of cloud computing services, the provider hosts the hardware and/or software resources that end-users can access over a network connection. These resources are hosted on various servers that can be geographically distributed around the world. Understanding how to route each particular request can be challenging especially as demand on particular servers increase.

Overall, the examples herein of some prior or related systems and their associated limitations are intended to be illustrative and not exclusive. Upon reading the following, other limitations of existing or prior systems will become apparent to those of skill in the art.

### SUMMARY

Various embodiments of the present technology generally relate to systems and methods for intelligent traffic management. More specifically, various embodiments of the present technology generally relate to intelligent traffic routing based on past traffic arrival patterns and current load state of target servers or scaling units. In accordance with some embodiments, traffic (e.g., domain name resolution requests) can be monitored. Based on the arrival patterns of the traffic, a prediction of future traffic can be generated (e.g., using pattern matching or machine learning). Some embodiments create a database of historical traffic generated from the traffic (e.g., domain name service requests). The historical database can be indexed, at least in part, based on subnets from which the traffic originated and application identifiers identifying applications.

The prediction of future traffic can be translated (e.g., by weighting subnet association) into load estimates. In addition, a status of one or more multiple scaling units capable of handling the traffic can be determined. In accordance with various embodiments, the status of the one or more scaling units can include an indication of scaling unit health, scaling unit utilization, scaling unit capacity, scaling unit resource utilization, scaling unit processor utilization rates, scaling unit wait times, scaling unit response times, scaling unit queue lengths, and/or other information. Future traffic can be intelligently routed based on the prediction of future traffic and the current status of the one or more scaling units. For example, a resource mapping can be created that indicates initial routing activity. In some embodiments, capacity at one or more of the scaling units can be reserved for a period of time to help ensure routed traffic is processed efficiently.

Embodiments of the present invention also include computer-readable storage media containing sets of instructions to cause one or more processors to perform the methods, variations of the methods, and other operations described herein.

While multiple embodiments are disclosed, still other embodiments of the present invention will become apparent to those skilled in the art from the following detailed description, which shows and describes illustrative embodiments of the invention. As will be realized, the invention is capable of modifications in various aspects, all without departing from the scope of the present invention. Accordingly, the drawings and detailed description are to be regarded as illustrative in nature and not restrictive.

### BRIEF DESCRIPTION OF THE DRAWINGS

Embodiments of the present technology will be described and explained through the use of the accompanying drawings in which:

FIG. 1 illustrates an example of an environment capable of implementing an intelligent traffic management system in accordance with some embodiments of the present technology;

FIG. 2 illustrates an example of multiple scaling units reporting to a central controller according to one or more embodiments of the present technology;

FIG. 3 illustrates an example of various components that may be used in an intelligent traffic management system in accordance with various embodiments of the present technology;

FIG. 4 illustrates an example of a set of operations for reserving resources that may be used in one or more embodiments of the present technology;

FIG. 5 illustrates an example of a set of operations for intelligently processing traffic requests that may be used in some embodiments of the present technology;

FIG. 6 illustrates an example of a set of operations for determining routing information associated with scaling units according to various embodiments of the present technology;

FIG. 7 illustrates a sequence diagram showing various communications between components of an intelligent traffic management system that may be used in some embodiments of the present technology; and

FIG. 8 illustrates an example of a computing system, which is representative of any system or collection of systems in which the various applications, services, scenarios, and processes disclosed herein may be implemented.

The drawings have not necessarily been drawn to scale. Similarly, some components and/or operations may be separated into different blocks or combined into a single block for the purposes of discussion of some of the embodiments of the present technology. Moreover, while the technology is amenable to various modifications and alternative forms, specific embodiments have been shown by way of example in the drawings and are described in detail below. The intention, however, is not to limit the technology to the particular embodiments described. On the contrary, the technology is intended to cover all modifications, equivalents, and alternatives falling within the scope of the technology as defined by the appended claims.

### DETAILED DESCRIPTION

Various embodiments of the present technology generally relate to systems and methods for intelligent traffic management. More specifically, various embodiments of the present technology generally relate to intelligent traffic routing based on past traffic arrival patterns and current load state of target servers or scaling units. Modern computing devices often access remote servers to access information, resources, webpages, services, and the like. Distributed large-scale cloud services can have hundreds of thousands of front-end servers. In many cases, the servers may be geographically spread out depending on demand. Developing systems that efficiently serve end-user traffic with the closest front-end that has available resources to serve the request can be difficult.

For example, domain name service (DNS) servers are located at multiple locations around the world to service a multitude of client devices needs access to distributed large-scale cloud services. These servers are often bucketized into scaling units by physical or logical attributes (e.g., dimension, forest, ring, etc.). Each scaling unit can have a different finite number of resources (e.g., compute, storage, disk etc.) which can make management difficult. Traditionally, these services have been over built creating a large buffer so that peak loads can easily be met. This can result in underutilization at off-peak times. Moreover, a variety of techniques have been developed to shed load when a server or scaling unit is too busy or becomes unresponsive.

Traditional traffic management techniques for routing and shedding traffic are done without knowledge of the current resource utilization of the scaling units absorbing the shed load or without any prediction of future traffic demands. In contrast, various embodiments of the present technology allow each scaling unit to publish load characteristics and/or available resources which can be used to make intelligent traffic management decisions. In addition to current load characteristics, predictions of future traffic (e.g., over the next hour) can be used to allocate and reserve resources within scaling unites so that the predicted future loads can easily be met.

In accordance with some embodiments, each scaling unit can publish its current load state (e.g., to a central entity or database). In some embodiments, each server can publish a current load state (e.g., every 30 seconds) to a central entity (e.g., ObjectStore or highly resilient key value repository). The current load state may also include, or separately report, reserved capacity for anticipated future workloads. The server can check the load state more frequently (e.g., every second) and upload if a change in load state is detected respectively triggering the aggregate computation. The central entity can aggregate the published information and compute the current load state for the scaling unit. Incoming traffic can then be used to predict future workloads (e.g., based on historical data). A traffic management plan can be created and workload capacity at different servers or scaling units can be reserved. As a result, traffic can be managed in an intelligent manner based on current load and predicted future loads.

Various embodiments of the present technology provide for a wide range of technical effects, advantages, and/or improvements to computing systems and components. For example, various embodiments include one or more of the following technical effects, advantages, and/or improvements: 1) intelligent traffic management that is based on current resource utilization of the scaling units as well as predicted traffic over a period of time; 2) predictive traffic management protocols; 3) proactive load management and resource reservations; 4) protocol agnostic traffic routing design; 5) improved DNS reservation system; 6) new techniques for traffic routing implementations that route traffic based on real-time prediction of anticipated future load on scaling units based on actual historical DNS responses; 7) scaling units with small fault domains directing traffic to self-based on anycast DNS; 8) optimization of latency of all the future requests so that an improved experience can be delivered; and/or 9) use of unconventional and non-routine operations to intelligently manage traffic.

Some embodiments include additional technical effects, advantages, and/or improvements to computing systems and components. In the following description, for the purposes of explanation, numerous specific details are set forth in order to provide a thorough understanding of embodiments of the present technology. It will be apparent, however, to one skilled in the art that embodiments of the present technology may be practiced without some of these specific details. While, for convenience, embodiments of the present technology are described with reference to a large data centers and cloud computing systems with dynamic topologies, embodiments of the present technology are equally applicable to various other instantiations where system monitoring and traffic management services are needed (e.g., network configuration).

The techniques introduced here can be embodied as special-purpose hardware (e.g., circuitry), as programmable circuitry appropriately programmed with software and/or firmware, or as a combination of special-purpose and programmable circuitry. Hence, embodiments may include a machine-readable medium having stored thereon instructions which may be used to program a computer (or other electronic devices) to perform a process. The machine-readable medium may include, but is not limited to, floppy diskettes, optical disks, compact disc read-only memories (CD-ROMs), magneto-optical disks, ROMs, random access memories (RAMs), erasable programmable read-only memories (EPROMs), electrically erasable programmable read-only memories (EEPROMs), magnetic or optical cards, flash memory, or other type of media/machine-readable medium suitable for storing electronic instructions.

The phrases “in some embodiments,” “according to some embodiments,” “in the embodiments shown,” “in other embodiments,” and the like generally mean the particular feature, structure, or characteristic following the phrase is included in at least one implementation of the present technology, and may be included in more than one implementation. In addition, such phrases do not necessarily refer to the same embodiments or different embodiments.

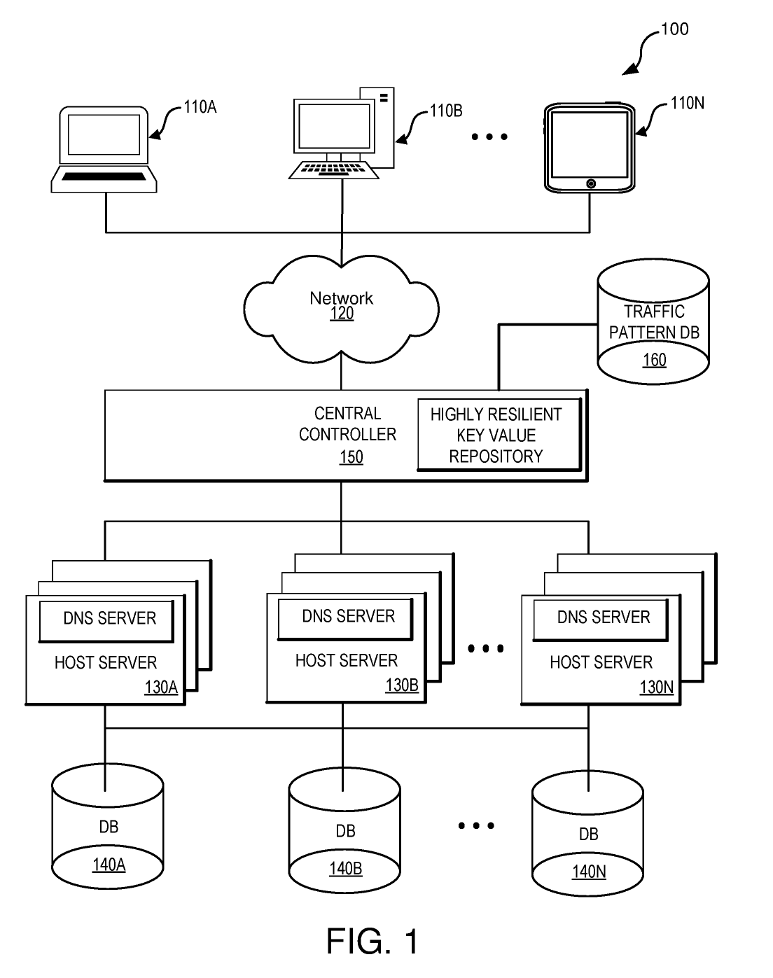

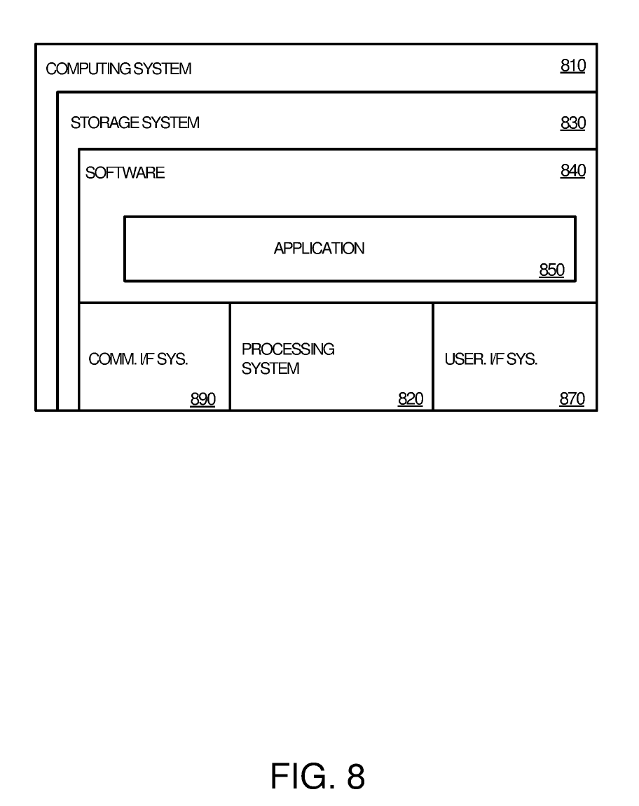

FIG. 1 illustrates an example of an environment capable of implementing an intelligent traffic management system in accordance with some embodiments of the present technology. As illustrated in FIG. 1, environment 100 may include one or more computing devices 110A-110N, communications network 120, host servers 130A-130N, database 140A-140N, central controller platform 150, historical traffic database 160. Computing devices 110A-110N can be any computing system capable of running an application natively or in the context of a web browser, streaming an application, or executing an application in any other manner. Examples of computing system 110 include, but are not limited to, personal computers, mobile phones, tablet computers, desktop computers, laptop computers, wearable computing devices, thin client computing devices, virtual and/or augmented reality computing devices, virtual machine hosting a computing environment, distributed application, server computer, computing cluster, application hosted as software as a service (SaaS), application running on a platform as a service (PaaS), application running on an infrastructure as a service (IaaS) or any other form factor, including any combination of computers or variations thereof. One such representative architecture is illustrated in FIG. 8 with respect to computing system 810.

Those skilled in the art will appreciate that various components (not shown) may be included in computing devices 110A-110N to enable network communication with communications network 120. In some cases, communications network 120 may be comprised of multiple networks, even multiple heterogeneous networks, such as one or more border networks, voice networks, broadband networks, service provider networks, Internet Service Provider (ISP) networks, and/or Public Switched Telephone Networks (PSTNs), interconnected via gateways operable to facilitate communications between and among the various networks.

As illustrated in FIG. 1, in some embodiments, a DNS server can be co-hosted with each of the host servers 130A-130N. In other embodiments, the DNS server can live separately and have an intelligent lookup to identify which is the preferred host server 130A-130N based on the information (e.g., LDNS IP) extracted out of the DNS packet. In accordance with some embodiments, there may be one instance of Object Store/Central Controller 150 per ring. For example, in some embodiments, a certain number of rings (e.g., three rings) may be deployed for world-wide capacity to maintain fault domains (e.g., to limit the blast radius).

Central controller 150 can receive, pull, and process status information about from various system components such as host servers 130A-130N, databases 140A-140N, utility grids, automatic transfer switches, uninterrupted power supplies, power distribution units, cooling equipment, backup generators, and other components. For example, central controller 150 may receive various signals such as processor utilization rates, wait times, response times, queue lengths, and the like. In addition, central controller 150 can receive indications of traffic data from various subnets. This information can be used to identify patterns within historical database 160. Central controller 150 can use these signals and conditions to make load-shedding and intelligent routing decisions based on knowledge of load of the destination device. As such, traffic can be intelligently routing to scaling units or servers based current load, future predicted traffic demands, resources, location, and/or other factors.

Intelligent traffic management features of various embodiments can be designed to be protocol agnostic. For example, in some embodiments, intelligent traffic routing can be conducted at the DNS layer which is agnostic to protocols consuming load state information (e.g., CPU, Disk, Memory, and the like) which is also agnostic to protocols stored on a central store which is also not protocol-specific. This ensures that routing of HTTP and non-HTTP requests is coordinated and proportional.

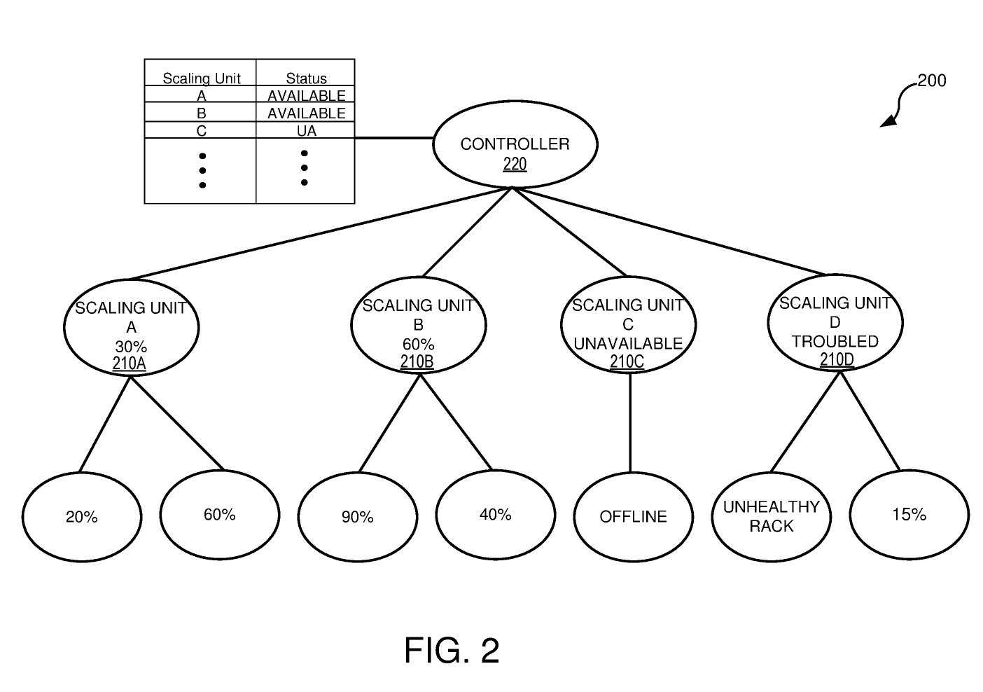

FIG. 2 illustrates an example 200 of multiple scaling units 210A-210D reporting to a central controller 220 according to one or more embodiments of the present technology. Each scaling unit 210A-210D can identify the current status (e.g., health, utilization, capacity, etc.) of each rack. For example, as illustrated in FIG. 2, scaling unit A gets a report of 20% and 60% capacity, scaling unit B receives a report of 90% and 20% capacity, scaling unit C receives reports of the racks being offline, and scaling unit D receives a report of an unhealthy rack and a utilization of 15%. Each scaling unit can use this information to generate a current status (e.g., percent utilization, available capacity, tiered capacity levels, etc.) of the scaling unit's availability which is reported to central controller 220 and published to DNS servers and/or other system components.

In some embodiments, central controller 220 can reserve capacity at scaling units 210A-201D based on future predictions (e.g., predicted traffic over the next thirty minutes, one hour, two hours, etc.). Reserved capacity can be included in the capacity reports. For example, reserved capacity can be aggregated into the capacity or may be reported as a separate indicator. Based on the current resource utilization being reported to central controller 220, intelligent traffic management and routing decisions can be performed. For example, incoming traffic requests can be routed to scaling units based on the current resource utilization and reserved capacity on the scaling units.

Some embodiments provide for a protocol agnostic load-shedding design (e.g., coordinated and proportional load-shedding across protocols). Load-shedding features of various embodiments can be designed to be protocol agnostic. For example, in some embodiments, load-shedding can be conducted at the DNS layer which is agnostic to protocols consuming load state information (e.g., CPU, disk, memory, number of threads, etc.) and future anticipated workload which are also agnostic to protocols stored on a central store which is also not protocol-specific. This ensures that shedding of HTTP and non-HTTP requests can be coordinated and proportional.

Some embodiments provide for traffic routing implementations that route traffic based on real-time prediction of anticipated load on scaling units based on actual historical DNS responses. Scaling units 210A-210D with small fault domains can direct traffic to itself based on an anycast DNS in some embodiments. Various embodiments can leverage anycast TCP or central store/brain. As a result, a small set of resources can identify if additional traffic should be routed to a scaling unit by simply withdrawing/publishing its IP address on an anycast DNS ring.

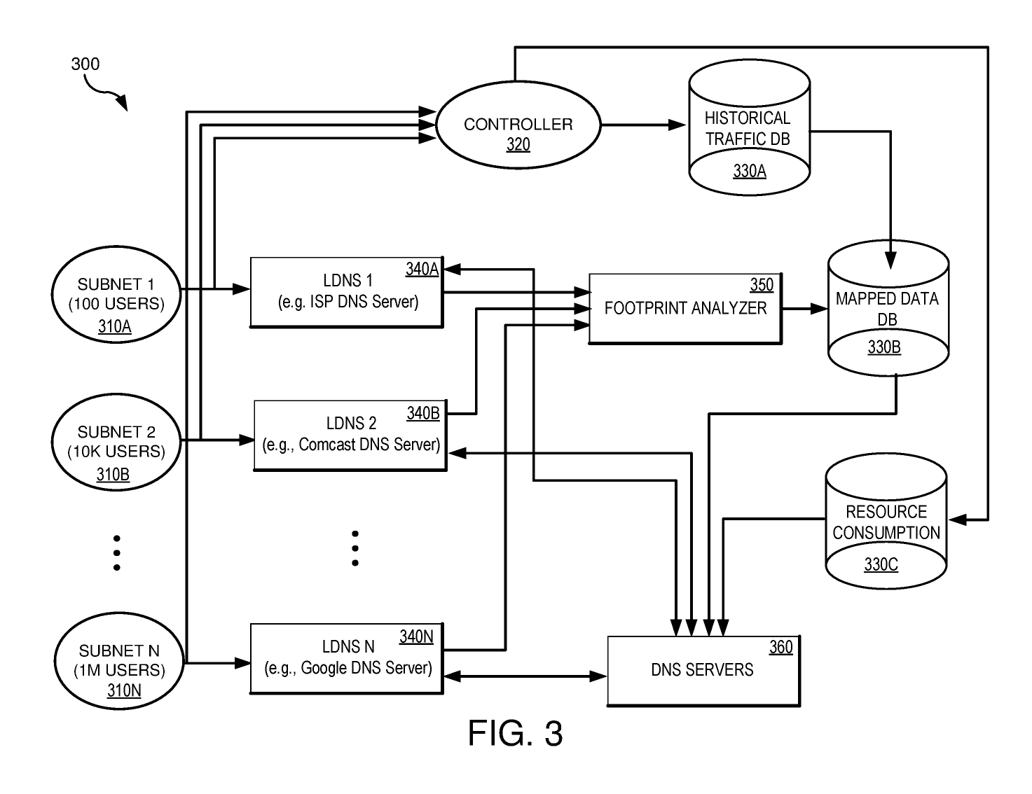

FIG. 3 illustrates an example of various components that may be used in an intelligent traffic management system in accordance with various embodiments of the present technology. As illustrated in FIG. 3, various subnets 310A-310N can support multiple users (e.g., 100 users, 10 k users, or 1 million users). A requesting device can submit a DNS request (e.g., a request to translate a hostname of a domain to an IP address). These DNS requests and other traffic can be monitored by controller 320. Controller 320 can then use the traffic coming from the subnets to identify a historical load from data stored within historical traffic database 330A. The historical data stored in database 330A can be indexed by applications identifiers, client subnets, and/or other characteristics. The identified load can then be weighted based on mapped data from database 330B. The weights may vary based on client subnet to DNS subnet data. Any currently reported loads from the scaling units to controller 320 can be stored in resource consumption database 330C.

The DNS requests land at an LDNS server 340A-340N which reports the activity to the footprint analyzer 350. Footprint analyzer 350 has information regarding the topology of the scaling units and the (approximate) number of users associated with each subnet. This information can be used in computation of resource mapping that can be used to minimize or nearly optimize latency. LDNS server 340A-340N can receive routing information from DNS servers 360. This routing information can include scaling unit status information (e.g., critically loaded, unavailable, likely to deny requests, etc.) as well as specific routing information for traffic from particular application identifiers, subnets, etc. that were identified in the resource mapping.

DNS servers 360 can publish routing information to LDNS servers 340A-340N based on the capacity entering the service, current resource information from database 330C, resource mapping, and/or future predicted load for a time period. The published routing information can include, but is not limited to, the following: capacity unit name, list of constituent machines, unicast external IP address of the rack, switch state, and/or activity state. As a result, the components shown in FIG. 3 can focus on moving load in a routing network between a finite number of service instance (e.g., set of machines and a load balancer, single machine, etc.). Each service instance's sole purpose can be to route requests to the next hop. Load feedback can be based on actual measured load from the service instances, connections, requests, CPU and/or other logical/physical resources. As a result, some embodiments optimize for latency over a set of existing resources. A near perfect answer may not be necessary, but rather a close to good approximation may be sufficient in many embodiments. The resource mapping can deal with balancing connections and in some cases shifting requests.

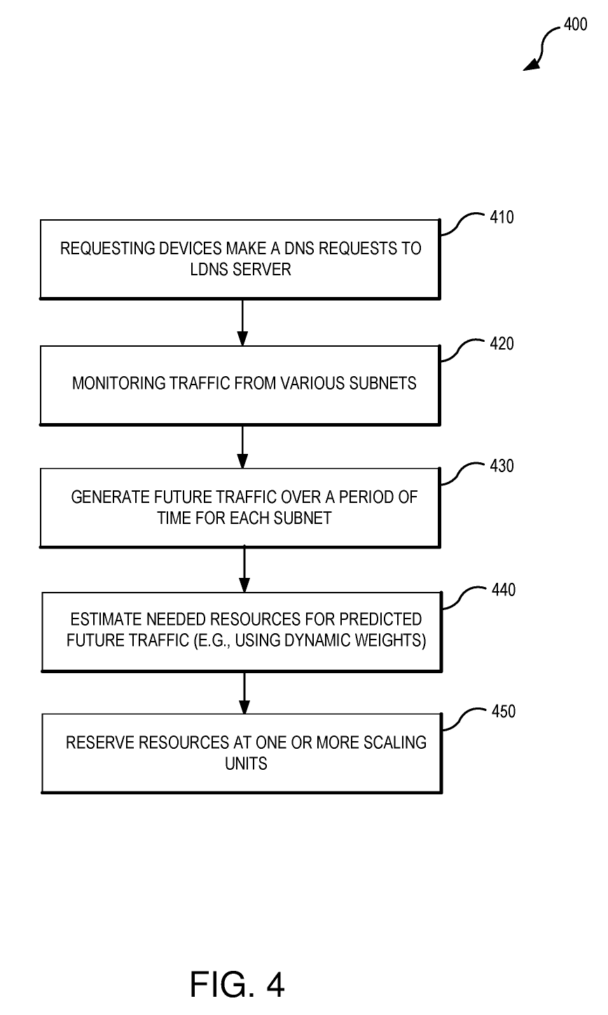

FIG. 4 illustrates an example of a set of operations 400 for reserving resources that may be used in one or more embodiments of the present technology. As illustrated in FIG. 4, requesting operation 410 receives, at an LDNS server, DNS requests from requesting devices. Monitoring operation 420 monitors the traffic from the various subnets. Generation operation 430 can use this detected activity to generate future predictions of traffic over a period of time for each subnet based on historical patterns. For example, the future predictions may indicate that 1000 DNS requests will translate to 1 million application requests over the next hour.

In some embodiments, generation operation 430 may use various artificial intelligence or machine learning algorithms to identify the which historical pattern is mostly likely to be repeated (e.g., over the next hour). Various inputs such as current day, current time, associated applications, subnets, geographic distributions, and other information may be used by the machine learning or artificial intelligence systems. In other embodiments, generation operation 430 may use pattern matching algorithms to identify predicted future traffic by matching corresponding patterns within the historical data. These predictions can be weighted or translated to create an estimate of server load by estimation operation 440. Based on the estimated server load, reservation operation 450 can reserve resources at one or more servers or scaling units so that the requests will be timely processed as they arrive.

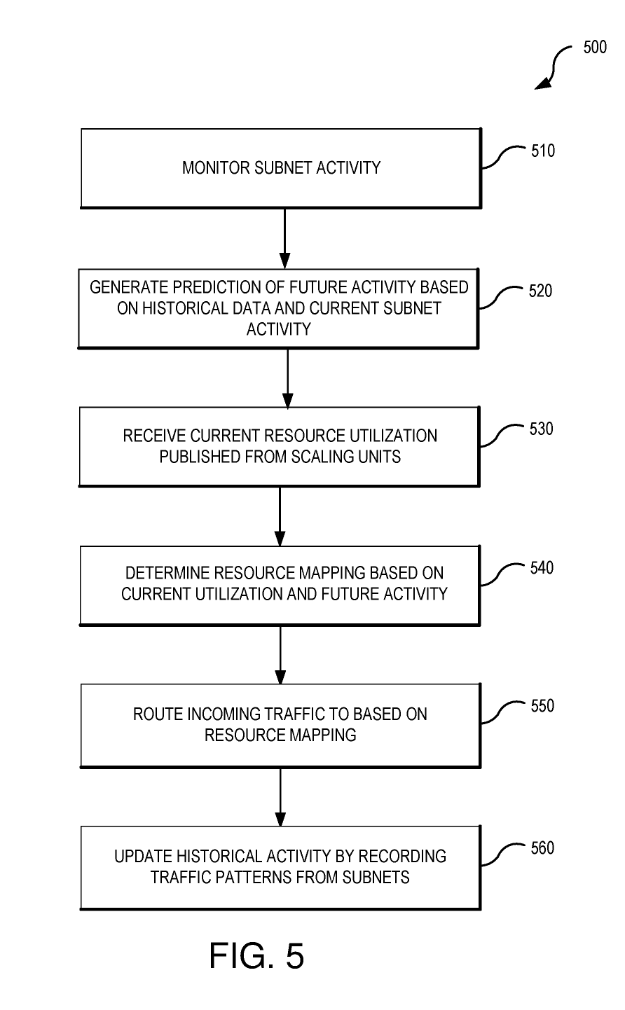

FIG. 5 illustrates an example of a set of operations 500 for intelligently processing traffic requests that may be used in some embodiments of the present technology. As illustrated in FIG. 5, monitoring operation 510 monitors traffic activity from various subnets. Generation operation 520 can use the current activity detected by monitoring operation 510 to predict future activity. In accordance with various embodiments, these predications can be based on historical traffic data. Some embodiments can provide coarse predications that provide only peak traffic over a time period while other embodiments may provide more gradual predications (e.g., load predictions for each five or fifteen minute period). The data matching can be restricted to particular days (e.g., day of week, holiday, etc.), time of day, subnet, and/or other factors. This data can then be weighted (e.g., based on number of users per subnet) to create an estimate of the workload needed.

Receiving operation 530 can receive current resource utilizations published from the servers or scaling units. This published resource utilization can include actual loads and resource reservations in some embodiments. Determination operation 540 can then determine a resource mapping based on the current utilization and the future predicted activity (e.g., over the next hour). The resource mapping can be used by the DNS server to route, during routing operation 550, the traffic to the desired scaling unit. Recording operation 560 can then update the historical data to include the actual traffic that occurred. In some embodiments, this information along with the prediction may be used to update the machine learning or pattern matching algorithms so that future predictions improve.

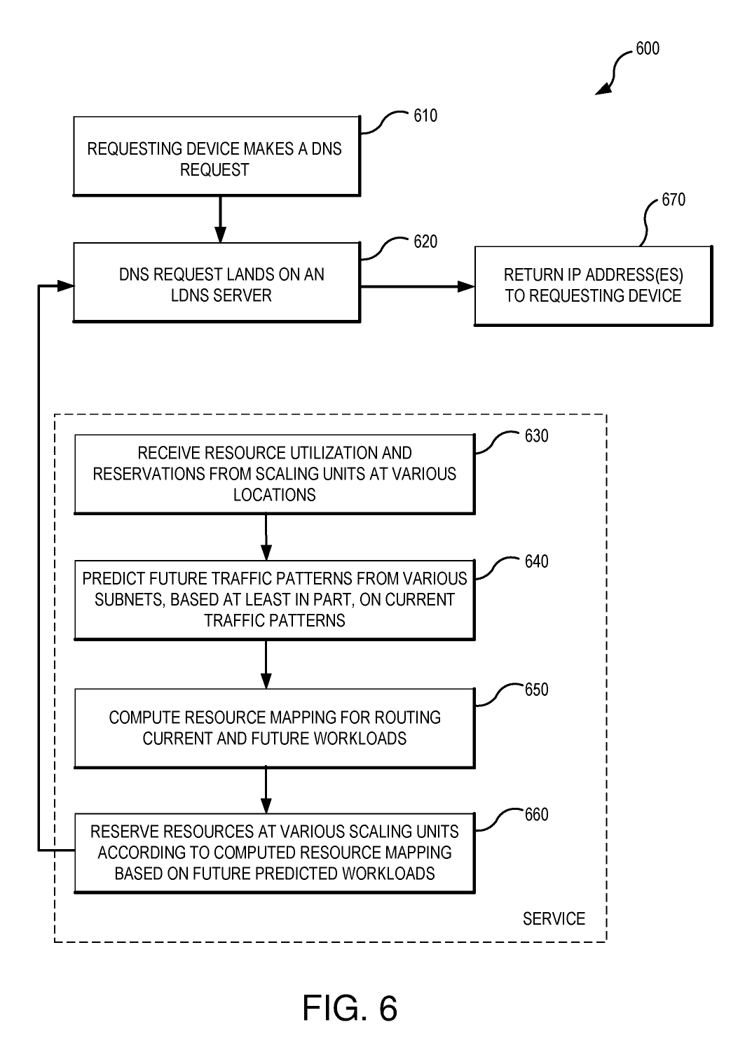

FIG. 6 illustrates an example of a set of operations 600 for determining routing information associated with scaling units according to various embodiments of the present technology. As illustrated in FIG. 6, during requesting operation 610 a requesting device can submit a DNS request (e.g., a request to translate a hostname of a domain to an IP address). During landing operation 620, the DNS request lands at a DNS (or LDNS) server. The DNS server can be consistently updated (e.g., via an availability service) with information regarding the availability of various scaling units.

During utilization operation 630, a service (e.g., associated with or running on a DNS server) can determine the resource utilization and reservations from various scaling units. Predication operation 640 can be used to create estimates of future workloads and traffic from various subnets, based at least in part, on current traffic patterns. Computation operation 650 can compute a resource mapping for routing the current and future workloads. For example, service may first prefer servers that are closest (e.g., geographically, logically, etc.) to the submitting device or attempt (or prefer) to return the closest scaling units (e.g., from the same ring). However, the scaling units that may be closer may be identified as being critically loaded, unavailable, likely to deny requests, etc. These scaling units can be excluded from the resource mapping and the IP addresses of the next closest scaling units can be identified. Reservation operation 660 can reserve capacity at various scaling units according to the computed resource mapping so that latency is minimized. The service can publish routing information based on the resource mapping. So that return operation 670 can return IP addresses to a requesting device.

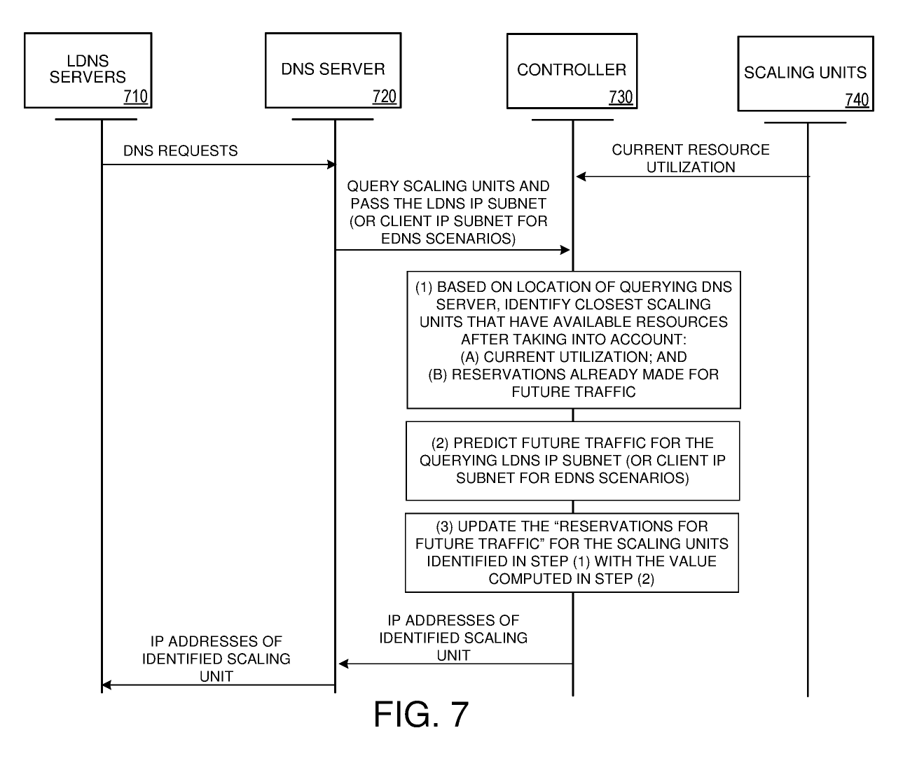

FIG. 7 illustrates a sequence diagram showing various communications between components of an intelligent traffic management system that may be used in some embodiments of the present technology. As illustrated in FIG. 7, LDNS servers 710 submit DNS requests to DNS server 720. DNS server 720 can process the DNS requests submit a query to controller 730. The query can request identification of available scaling units and may include the LDNS IP subnet (or client IP subnet for EDNS scenarios). Controller 730 can receive current resource utilization information from scaling units 750. The current resource utilization information can be published periodically (e.g., every 30 seconds).

Controller 730 can identify the closest scaling units that have available resources based on the location of querying DNS server 720. In accordance with some embodiments, controller 730 may take into account current utilization and/or reservations already made on scaling units 740 in identifying the closest scaling units with available resources. Controller 730 can identify current traffic patterns by matching the patterns to historical traffic data. Using this and possibly other information, controller 730 can generate a future traffic prediction for the querying LDNS IP subnet (or client IP subnet for EDNS scenarios). Based on the future predictions, controller 730 can update the reservations for future traffic for the closest scaling units identified. The IP addresses of the identified scaling unit can the be returned to DNS server 720 and LDNS servers 710.

FIG. 8 illustrates computing system 810, which is representative of any system or collection of systems in which the various applications, services, scenarios, and processes disclosed herein may be implemented. For example, computing system 810 may include server computers, blade servers, rack servers, and any other type of computing system (or collection thereof) suitable for carrying out the enhanced collaboration operations described herein. Such systems may employ one or more virtual machines, containers, or any other type of virtual computing resource in the context of supporting enhanced group collaboration.

Computing system 810 may be implemented as a single apparatus, system, or device or may be implemented in a distributed manner as multiple apparatuses, systems, or devices. Computing system 810 includes, but is not limited to, processing system 820, storage system 830, software 840, applications for process 850, communication interface system 860, and user interface system 870. Processing system 820 is operatively coupled with storage system 830, communication interface system 860, and an optional user interface system 870.

Processing system 820 loads and executes software 840 from storage system 830. When executed by processing system 820 for deployment of scope-based certificates in multi-tenant cloud-based content and collaboration environments, software 840 directs processing system 820 to operate as described herein for at least the various processes, operational scenarios, and sequences discussed in the foregoing implementations. Computing system 810 may optionally include additional devices, features, or functionality not discussed for purposes of brevity.

Referring still to FIG. 8, processing system 820 may comprise a micro-processor and other circuitry that retrieves and executes software 840 from storage system 830. Processing system 820 may be implemented within a single processing device, but may also be distributed across multiple processing devices or sub-systems that cooperate in executing program instructions. Examples of processing system 820 include general purpose central processing units, application specific processors, and logic devices, as well as any other type of processing device, combinations, or variations thereof.

Storage system 830 may comprise any computer readable storage media readable by processing system 820 and capable of storing software 840. Storage system 830 may include volatile and nonvolatile, removable and non-removable media implemented in any method or technology for storage of information, such as computer readable instructions, data structures, program modules, or other data. Examples of storage media include random access memory, read only memory, magnetic disks, optical disks, flash memory, virtual memory and non-virtual memory, magnetic cassettes, magnetic tape, magnetic disk storage or other magnetic storage devices, or any other suitable storage media. In no case is the computer readable storage media a propagated signal.

In addition to computer readable storage media, in some implementations storage system 830 may also include computer readable communication media over which at least some of software 840 may be communicated internally or externally. Storage system 830 may be implemented as a single storage device, but may also be implemented across multiple storage devices or sub-systems co-located or distributed relative to each other. Storage system 830 may comprise additional elements, such as a controller, capable of communicating with processing system 820 or possibly other systems.

Software 840 may be implemented in program instructions and among other functions may, when executed by processing system 820, direct processing system 820 to operate as described with respect to the various operational scenarios, sequences, and processes illustrated herein. For example, software 840 may include program instructions for directing the system to perform the processes described above.

In particular, the program instructions may include various components or modules that cooperate or otherwise interact to carry out the various processes and operational scenarios described herein. The various components or modules may be embodied in compiled or interpreted instructions, or in some other variation or combination of instructions. The various components or modules may be executed in a synchronous or asynchronous manner, serially or in parallel, in a single threaded environment or multi-threaded, or in accordance with any other suitable execution paradigm, variation, or combination thereof. Software 840 may include additional processes, programs, or components, such as operating system software, virtual machine software, or application software. Software 840 may also comprise firmware or some other form of machine-readable processing instructions executable by processing system 820.

In general, software 840 may, when loaded into processing system 820 and executed, transform a suitable apparatus, system, or device (of which computing system 810 is representative) overall from a general-purpose computing system into a special-purpose computing system. Indeed, encoding software on storage system 830 may transform the physical structure of storage system 830. The specific transformation of the physical structure may depend on various factors in different implementations of this description. Examples of such factors may include, but are not limited to, the technology used to implement the storage media of storage system 830 and whether the computer-storage media are characterized as primary or secondary storage, as well as other factors.

For example, if the computer readable storage media are implemented as semiconductor-based memory, software 840 may transform the physical state of the semiconductor memory when the program instructions are encoded therein, such as by transforming the state of transistors, capacitors, or other discrete circuit elements constituting the semiconductor memory. A similar transformation may occur with respect to magnetic or optical media. Other transformations of physical media are possible without departing from the scope of the present description, with the foregoing examples provided only to facilitate the present discussion.

In general, process 850 can be hosted in the cloud as a service, distributed across computing devices between the various endpoints, hosted as a feature of a cloud enabled information creation and editing solution. Communication interface system 860 may include communication connections and devices that allow for communication with other computing systems (not shown) over communication networks (not shown). Examples of connections and devices that together allow for inter-system communication may include network interface cards, antennas, power amplifiers, RF circuitry, transceivers, and other communication circuitry. The connections and devices may communicate over communication media to exchange communications with other computing systems or networks of systems, such as metal, glass, air, or any other suitable communication media. The aforementioned media, connections, and devices are well known and need not be discussed at length here.

User interface system 870 may include a keyboard, a mouse, a voice input device, a touch input device for receiving a touch gesture from a user, a motion input device for detecting non-touch gestures and other motions by a user, and other comparable input devices and associated processing elements capable of receiving user input from a user. Output devices such as a display, speakers, haptic devices, and other types of output devices may also be included in user interface system 870. In some cases, the input and output devices may be combined in a single device, such as a display capable of displaying images and receiving touch gestures. The aforementioned user input and output devices are well known in the art and need not be discussed at length here. In some cases, the user interface system 870 may be omitted when the computing system 810 is implemented as one or more server computers such as, for example, blade servers, rack servers, or any other type of computing server system (or collection thereof).

User interface system 870 may also include associated user interface software executable by processing system 820 in support of the various user input and output devices discussed above. Separately or in conjunction with each other and other hardware and software elements, the user interface software and user interface devices may support a graphical user interface, a natural user interface, an artificial intelligence agent (e.g. an enhanced version of Microsoft's Cortana assistant, Amazon's Alexa, or Apple's Siri, Google's Assistant, etc.), or any other type of user interface, in which a user interface to a productivity application may be presented.

Communication between computing system 810 and other computing systems (not shown), may occur over a communication network or networks and in accordance with various communication protocols, combinations of protocols, or variations thereof. Examples include intranets, internets, the Internet, local area networks, wide area networks, wireless networks, wired networks, virtual networks, software defined networks, data center buses, computing backplanes, or any other type of network, combination of network, or variation thereof. The aforementioned communication networks and protocols are well known and need not be discussed at length here. In any of the aforementioned examples in which data, content, or any other type of information is exchanged, the exchange of information may occur in accordance with any of a variety of well-known data transfer protocols.

The functional block diagrams, operational scenarios and sequences, and flow diagrams provided in the figures are representative of exemplary systems, environments, and methodologies for performing novel aspects of the disclosure. While, for purposes of simplicity of explanation, methods included herein may be in the form of a functional diagram, operational scenario or sequence, or flow diagram, and may be described as a series of acts, it is to be understood and appreciated that the methods are not limited by the order of acts, as some acts may, in accordance therewith, occur in a different order and/or concurrently with other acts from that shown and described herein. For example, those skilled in the art will understand and appreciate that a method could alternatively be represented as a series of interrelated states or events, such as in a state diagram. Moreover, not all acts illustrated in a methodology may be required for a novel implementation.

The descriptions and figures included herein depict specific implementations to teach those skilled in the art how to make and use the best option. For the purpose of teaching inventive principles, some conventional aspects have been simplified or omitted. Those skilled in the art will appreciate variations from these implementations that fall within the scope of the invention. Those skilled in the art will also appreciate that the features described above can be combined in various ways to form multiple implementations. As a result, the invention is not limited to the specific implementations described above, but only by the claims and their equivalents.

What is claimed is:

1. A method comprising:
monitoring domain name resolution requests to translate a domain name into an Internet protocol (IP) address;
generating a prediction of future traffic based on current arrival patterns of the domain name resolutions requests;
determining a status of one or more multiple scaling units capable of handling traffic from the IP address; and
routing the future traffic based on the prediction generated and the status of the one or more scaling units.

2. The method of claim 1, wherein each status of the one or more scaling units includes an indication of scaling unit health, scaling unit utilization, scaling unit capacity, scaling unit resource utilization, scaling unit processor utilization rates, scaling unit wait times, scaling unit response times, or scaling unit queue lengths.

3. The method of claim 1, wherein monitoring domain name resolution requests includes identifying subnets associated with each domain name resolution requests and generating the prediction of future traffic includes weighting the current arrival patterns associated with each subnet.

4. The method of claim 1, wherein monitoring domain name resolution requests includes identifying subnets associated with each domain name resolution requests.

5. The method of claim 1, further comprising reserving capacity at some of the one or more scaling units based on the prediction of future traffic.

6. The method of claim 1, further comprising creating a database of historical traffic generated from domain name service requests, wherein the database is indexed, at least in part, based on subnets from which the domain name service requests originated and application identifiers identifying applications associated with the domain name service requests.

7. The method of claim 6, wherein generating the prediction of future traffic include using machine learning or pattern matching based on the current arrival patterns of the domain name resolutions requests to identify similar activity in the database.

8. A system comprising:
a historical database having stored thereon historical traffic patterns associated with one or more subnets
a controller to monitor current traffic from one or more devices associated with one or more subnets and generate a prediction of future traffic based on the current traffic;
a helper service to determine a status of one or more multiple scaling units capable of handling the current traffic; and
a domain name service server to route the future traffic based on the prediction and the status of the one or more scaling units.

9. The system of claim 8, wherein the controller uses an artificial intelligence system to ingest the current traffic and historical traffic patterns to generate the prediction of future traffic.

10. The system of claim 9, wherein the prediction of future traffic includes a peak load over a period of time.

11. The system of claim 9, wherein controller reserves capacity at one or more of the scaling units to process the future traffic.

12. The system of claim 8, further comprising a topology service to collect topology information of a data center.

13. A computer-readable storage medium containing a set of instructions when executed by one or more processors to cause a machine to:
monitor traffic associated with one or more subnets;
generate a prediction of future traffic based on current arrival patterns of the traffic;
determine a status of one or more multiple scaling units capable of handling traffic associated with the one or more subnets; and
route the future traffic based on the prediction generated and the status of the one or more scaling units.

14. The computer-readable storage medium of claim 13, wherein each status includes an indication of scaling unit health, scaling unit utilization, scaling unit capacity, scaling unit resource utilization, scaling unit processor utilization rates, scaling unit wait times, scaling unit response times, or scaling unit queue lengths.

15. The computer-readable storage medium of claim 13, wherein the set of instructions further cause the one or more processors to identify a topology of the one or more scaling units.

16. The computer-readable storage medium of claim 13, wherein to determine the status of the one or more scaling units, the machine actively polls each of the one or more scaling units.

17. The computer-readable storage medium of claim 13, wherein the set of instructions when executed by the one or more processors cause the machine to identify the one or more subnets associated with the traffic and an application identifier.

18. The computer-readable storage medium of claim 13, wherein the set of instructions when executed by the one or more processors cause the machine to reserve capacity at some of the one or more scaling units based on the prediction of future traffic.

19. The computer-readable storage medium of claim 13, wherein the set of instructions when executed by the one or more processors cause the machine to record the traffic and create a database of historical traffic that is indexed, at least in part, based on subnets from which the traffic originated and application identifiers identifying applications associated with the traffic.

20. The computer-readable storage medium of claim 19, wherein the set of instructions when executed by the one or more processors further cause the machine to generate the prediction of future traffic using machine learning or pattern matching based on the current arrival patterns of the traffic to identify similar activity in the historical database.
